(19) United States
(12) Patent Application Publication
(10) Pub. No.: US 2002/0190452 A1
(43) Pub. Date: Dec. 19, 2002

(54) Coil spring having non-circular coils

(76) Inventor: Barry Drager, Houston, TX (US)

Correspondence Address: Tim Cook, Browning Bushman P. C., Suite 1800, 5718 Westheimer, Houston, TX, 77057, US

(21) Appl. No.: 10/124,497

(22) Filed: Apr. 17, 2002

Related U.S. Application Data
(60) Provisional application No. 60/299,397, filed on Jun. 19, 2001.

(51) Int. Cl. F16F 1/06

(52) U.S. Cl. 267/180

(57) ABSTRACT

A coil spring having a substantially circular arc on two sides and a flattened opposite side is provided. The flattened opposite sides may be configured with a radius of curvature that is substantially greater than the radius of curvature of the substantially arcuate sides, or the flattened opposite sides may in fact be flat. Such a configuration resists flexural movement in one direction more than it resists flexture in a perpendicular direction.

This application claims priority from Provisional U.S. patent application Ser. No. 60/299,397 filed Jun. 19, 2001.

### FIELD OF THE INVENTION

The present invention relates generally to the field of coil springs and, and, more particularly, to a coil spring made from a hot coil process with the coils having curved ends and flat sides, generally in the shape of a race track configuration in profile. The coil spring is particularly adapted for applications in which axial flexing is desirable in a first direction and undesirable at right angles to the first direction.

### BACKGROUND OF THE INVENTION

The genesis of the present invention was the realization of certain defects in known rubber springs which are commonly used in some shaker systems. The rubber spring is formed of layers of metal plating separated by resilient vulcanized rubber. The rubber spring is typically mounted between an exciter, which develops a vibratory action, and a device which is to receive the vibratory action, such as for example a conveyor.

Such rubber springs have a number of shortcomings, notably an inconsistency in performance which is exacerbated by changes in temperature. Further, the temperature of the rubber is made even harder to control because thermal energy is generated internally whin the rubber of the spring simply by its use. When the device which is to receive the vibratory action of the exciter requires carefully controlled and consistent motion, the rubber spring has been found to be less than ideal.

One attempt to overcome these drawbacks of the rubber spring in such applications involves the use of one or more coil springs. While eliminating many of the problems of inconsistent performance due to changes in temperature, the coil spring has not proven to be satisfactory because it tends to flex and gyrate in a plane perpendicular to the axis of the coil spring. In order to limit this flexure and gyration, the coil springs have been placed within square barriers, so that only vertical movement of the coil spring is permitted. Such spring devices have also been provided with a torsion bar extending a substantial distance within the confines of the coils for limiting transaxial flexure. These proposed solutions, however, brought along their own problems, including the difficulty in stalling the square barriers in some shaker applications, and the tendency of coil spring to expand radially when compressed.

Thus, there remains a need for a spring which is adapted to transfer vibratory action from an exciter to a device to receive the vibratory action. The spring must be consistent and predictable in performance, and fit into a rectangular form factor, or between two parallel plates in order to adapt to the structure of typical shaker and similar structures. The present invention addresses these and other needs in the art.

### SUMMARY OF THE INVENTION

The present invention comprises a coil spring having a substantially circular arc on two sides, and flattened opposite sides. The flattened opposite sides may be configured with a radius of curvature that is substantially greater than the radius of curvature of the substantially arcuate sides, or the flattened opposite sides may in fact be flat. Such a configuration resists flexural movement on one direction more than it resists flexure in a perpendicular direction.

A feature of the present invention is that the coil spring is formed of a hot coil process. In such a process, the stock material is heated to desired temperature and then coiled substantially continuously about a mandrel to form the coils. The mandrel has a cross section that is oval or race track in cross section. The ends of the coil include that parallel surfaces for placement between the exciter and the device adapted to receive the oscillations from the exciter.

These and other features and advantages of this invention will be readily apparent to those skilled in the art from a review of the following detailed description along with the accompanying drawings.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is an elevation view of the spring of this invention, showing the spring between an exciter and a device to receive vibrations from the exciter.

FIG. 2 is a top view of the coil spring between substantially parallel barriers.

FIG. 3 is a perspective view of the spring.

### DETAILED DESCRIPTION OF A PREFERRED EMBODIMENT

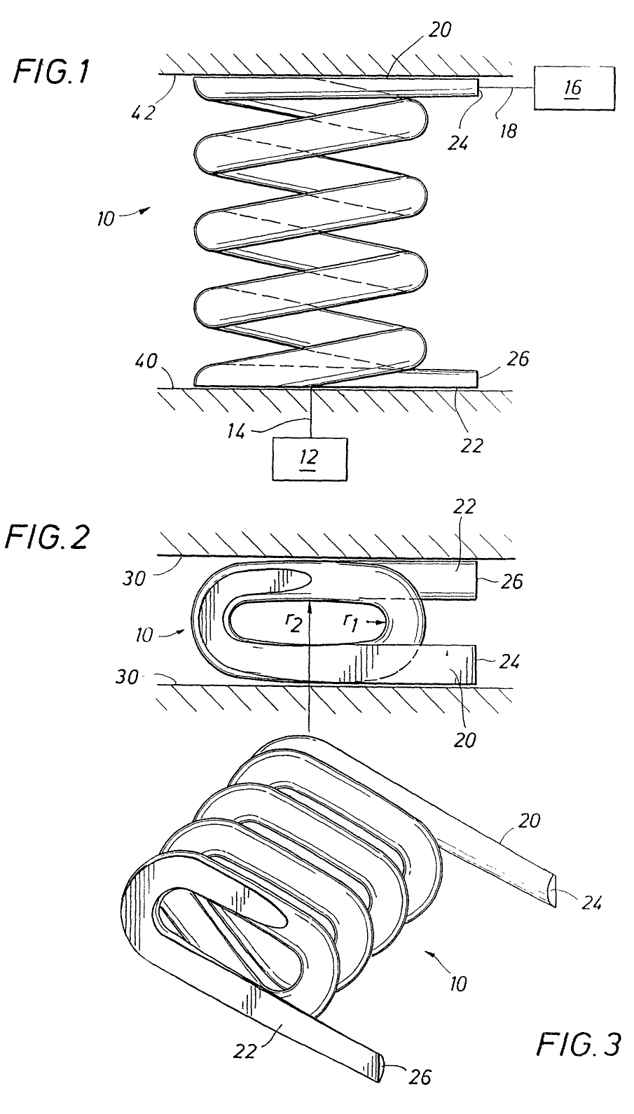

FIG. 1 shows a coil spring 10 of the invention coupled to an exciter 12 by means of a mechanical coupling 14. The coil spring 10 is coupled to the other end to a device 16, such as for example a conveyor, which is to be vibrated by the exciter 12. The coil spring 10 is coupled to the device 16 by means of a mechanical coupling 18.

The coil spring 10 includes a top surface 20 and a bottom surface 22, both of which are substantially flat and parallel to one another.

As shown in FIG. 2, the coil spring 10 has non-circular coils. The coils themselves are preferably circular in cross section but may also be non-circular in cross section if desired, such as for example they may be square or rectangular in cross section. In the non-circular coils, a first radius of curvature r₁ is substantially circular, although it may vary in radius along the arc of the coil. A second radius of curvature r₂ defines another portion of the coil, and the second radius of curvature is substantially greater than the first radius of curvature. In fact, the second radius of curvature may be infinite, i.e. the sides of the coil spring may be flat and parallel to one another.

The coil spring 10 also defines a first end 24 of the top surface 20 and a second end 26 of the bottom surface 22. The first and second ends of the coil spring terminate on the same side of the coil. The coil 10 is adapted to be positioned between parallel opposing plates 30. Note also in FIG. 3 that the surfaces 20 and 22 are substantially parallel.

The coil spring 10 of the present invention is preferably formed of a hot coiled process, although other methods and techniques may as well be used within the scope and spirit of the invention. The stock is preferably at least about 0.5″ in diameter, to serve the functions for which the coil spring was invented. The stock must be made of a material which is capable of heating treating in a full tempering process.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A coil spring comprising a coil formed from a hot coiled process from stock of at least about 0.5 inches in diameter, the coil defining a first radius of curvature and a second radius of curvature, wherein the second radius of curvature is substantially greater than the first radius of curvature.

2. The coil spring of claim 1 wherein the second radius of curvature is infinite.

3. The coil spring of claim 1, wherein the coil spring defines top and bottom flat surfaces.

4. The coil spring of claim 3, wherein the top and bottom flat surfaces are parallel to one another.

5. The coil spring of claim 1, wherein the coil is made of a material capable of tempering.

6. A coil spring comprising a solid stock defining a first and a second radius of curvature, wherein the radii of curvature of different from one another.

7. The coil spring of claim 6, wherein the spring is formed from a hot coiled process.

8. The coil spring of claim 6, wherein the stock is at least 0.5″ in diameter.

9. The coil spring of claim 8, wherein the stock is circular in cross section.

10. The coil spring of claim 8, wherein the stock is square in cross section.

11. The coil spring of claim 8, wherein the stock is rectangular in cross section.

12. The coil spring of claim 6, further comprising top and bottom flat surfaces.

13. The coil spring of claim 6, wherein the coil is adapted to fit within a rectangular form factor.
